(19) United States
(12) Patent Application Publication
(10) Pub. No.: US 2012/0109690 A1
(43) Pub. Date: May 3, 2012

(54) SYSTEM AND METHOD FOR RAPID EXCHANGE OF ACCIDENT SCENE DATA

(76) Inventors: Nissim Weinrauch, Jamaica Estate, NY (US); Amir Rephael, Flushing, NY (US)

(21) Appl. No.: 12/915,299

(22) Filed: Oct. 29, 2010

(51) Int. Cl. G06Q 40/00; G06Q 30/00; G06F 15/16

(52) U.S. Cl. 705/4; 709/217

(57) ABSTRACT

A system and method are disclosed for rapidly exchange accident related information. Data locator codes representing people and respective vehicles the people are insured to drive are generated and stored by central server. Software is installed on mobile devices that interface with the central server, and the software is configured with at least one of the data locator codes. A notification regarding an accident event involving two parties is received via the software. The central server receives accident information, which may include a data locator code the other driver, as well as images, voice messages or text information representing the accident. The central server uses the information to contact respective insurers of the parties, processes the data, and the parties can depart the scene without a need for police or other emergency care personnel.

### BACKGROUND OF THE INVENTION

1. Field of the Invention

The present invention relates generally to communications and, more particularly, to exchanging accident scene data rapidly.

2. Description of the Related Art

Relatively minor motor vehicle accidents (e.g., “fender benders”) typically involve minor vehicular damage, with no personal or medical injury to the parties. Even though no medical injury occurs and vehicles are not damaged to the point of being unsafe to drive, police and possibly medical personnel are often dispatched to the scene of an accident. This results in possible danger to lingering drivers on busy roads and in a significant waste of resources, frustration for the parties involved, and significant expense. In addition to the costs associated with dispatching police, fire and/or medical personnel, parties in fender bender accidents typically waste considerable amounts of time, for example, waiting for officials to complete processing information and reports at the scene.

In a typical minor “fender bender” accident, official authorities are dispatched to the scene, official records are made and the parties depart believing the incident is essentially behind them. However, even in such cases new facts may be alleged at some future time, which may be fraudulent or untrue. Such allegations usually relate to new or previously undisclosed injury. Sometimes, one party simply fabricates new evidence, or a new witness who was allegedly at the accident scene is introduced in the future. Defending against fraudulent or otherwise unscrupulous assertions can be very taxing to a party, both financially and emotionally, and results in additional waste and loss. Indeed, some drivers become overly distraught and confused, and hastily depart the scene of an accident without gathering even the basic information about the other vehicle or person(s) involved in the accident.

### SUMMARY

A system and method are disclosed for facilitating rapid exchanging and gathering of accident related information. To this end, data locator codes (“DLC”) representing people and/or insured vehicles are generated and stored by a central server. Software is installed on mobile devices that interface with the central server, and the software is configured with at least one of the data locator codes. A notification regarding an accident event involving two parties is received via the software. The central server receives accident information, which may include a data locator code of the other driver and/or vehicle, as well as images, voice messages or text information representing the accident, pursuant to a protocol stored on the mobile devices. The central server uses the information to contact respective insurance carriers of the parties in real time, processes the data and verifies the identities of the people and vehicles involved, and the parties can quickly depart the accident scene without a need for detailed, time consuming manual gathering of driver and vehicle data and the summoning of police or other emergency care personnel.

As an example of the application of the invention, subscribers of the service sign up with the central service and are assigned individual data locator codes. A particular DLC can designate a particular vehicle, as well as a particular driver associated with the vehicle. A database associated with the central server typically may contain full details associated with the data locator codes, or only abbreviated information. That is, the full detail including names, descriptions of the age and appearances of persons solely associated with a particular data locator code may, alternatively, be only known to a government authority or to an insurance company or be located at another safe location for such personal information, rather than at the central server.

Regardless, at the scene of an accident, drivers request each other's data locator codes (DLCs) which they then input into their mobile device which could be a Blackberry or an Iphone or a similar device. They then communicate with the central server on the basis of the data locator codes. The central server may then access its own database and provide a certain amount of information about the other driver or the other vehicle, sufficient to assure the person reporting the accident that the identity of the vehicle and the other driver are fully known to the database.

In certain instances, prior to replying to a mobile device, the central server communicates with either a government agency (e.g. Department of Motor Vehicles) or with the insurance companies to obtain such information.

Further, the software running in the mobile device may guide the user to either snap photos of the accident scene or even of the driver and passenger(s) of the other vehicle and/or one's own vehicle and transmit the same to the central server. Alternatively, if the other driver or vehicle is not a subscriber of the services provided by the central service, the subscriber who is involved in the accident may simply enter basic information, e.g. a vehicle VIN, and send it to the central service, on the basis of which the central server may immediately identify to the driver the full details of the other driver or his vehicle, so that the subscriber can leave the scene very quickly.

In accordance with one embodiment, the subscriber may simply photograph a driver's license or the insurance card of the other driver and/or vehicle and transmit the same to the central service server which then uses OCR (“Optical Character Recognition”) software to report back whether or not the other vehicle and driver have been properly and thoroughly identified.

Advantages to subscribers include the ability to quickly and completely gather information at an accident scene, avoid failing to gather information due to being confused, disorganized or stressed at the accident scene, as well as obtaining accurate times, date and accident location information and other information from the accident scene through the time stamping of the reporting at the mobile device and, or more preferably, at the central server which may know the whereabouts of the mobile device through the receipt of GPS coordinates from the reporting location. The central server is a reliable, disinterested third party authentication means, usable in courts or with insurance carriers to prove factual contentions and/or to settle claims. There are many other features and advantages of the invention which are more fully explicated in the detailed description of the invention.

Other features and advantages of the present invention will become apparent from the following description of the invention which refers to the accompanying drawings.

### BRIEF DESCRIPTION OF THE DRAWINGS

For the purpose of illustrating the invention, there is shown in the drawings several forms which are presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example hardware and system arrangement in a preferred embodiment;

FIG. 2 is a block diagram illustrating an example data locator code that represents the combination of a person and a vehicle, and a corresponding database of codes;

FIG. 3 illustrates the functional elements of an information central processor or server;

FIG. 4 illustrates a block diagram that represents parties and corresponding computing devices and features in accordance with an embodiment;

FIG. 5 is a flow chart illustrating example steps associated with installing and configuring a client software application on a mobile computing device; and

FIG. 6 is a flowchart illustrating steps associated with an example embodiment.

### DESCRIPTION OF THE EMBODIMENTS

In a preferred embodiment, a data locator code is generated that represents one or both a person's identity and/a motor vehicle, such as an automobile or motorcycle. The data in the code is useful to locate information about the person and/of the vehicle. The person may own the vehicle, or otherwise be an authorized driver of the vehicle according to an insurance policy, or a guest driver. In an embodiment, the data locator code is preferably short enough to be easily memorized and quickly copied and entered into the mobile device at an accident scene. It may be formatted as an alphanumeric code that includes three alphabetical characters, a separator (e.g., a space, dash or other character), and four numeric characters, yielding over 175 million unique codes, for example, BGU-7641. Adding another numeric provides over a billion codes.

The data locator code is preferably generated substantially automatically by a computing device, assigned to individuals and vehicles and provided to one or more parties that may include, for example, insurance companies, motor vehicle departments or the like. The data locator code preferably provides a uniform, standardized and anonymous index for a person and/or vehicle, a code that is useable by a plurality of parties. By centrally generating and managing data locator codes, the system provides a sort of data locator code clearinghouse, which assigns and distributes data locator codes to various parties for the particular purposes of the present invention. The codes used in conjunction with software running at the mobile devices (and at a central and other services) allow (but are not necessary) for achieving the aims of the present invention.

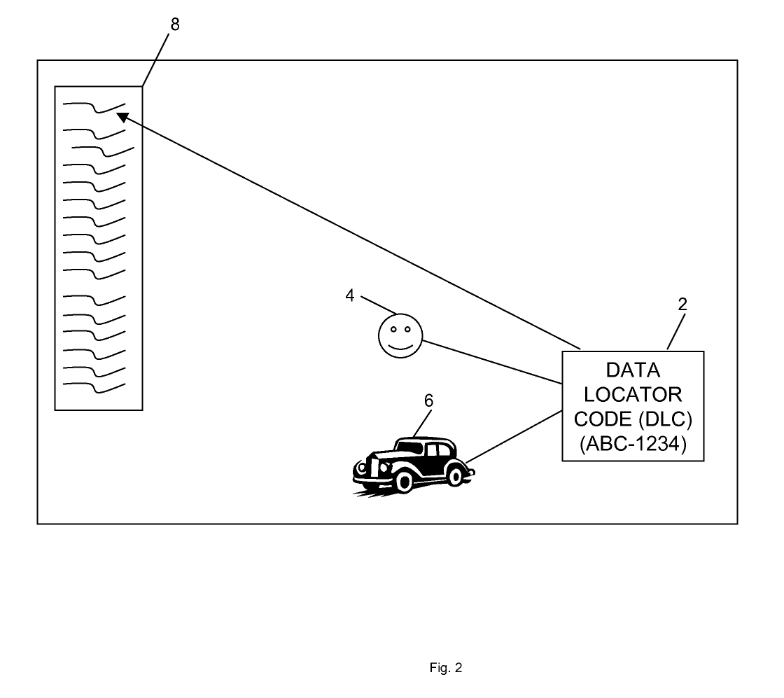

Referring now to the drawings, in which like reference numerals represent like elements, FIG. 2 is a block diagram illustrating an example data locator code (“DLC”) that represents a combination of a person 4 and a vehicle 6. In the example shown in FIG. 2, the vehicle 6 is an automobile. Also shown in FIG. 2 is database 8 that comprises a plurality of data locator codes 2 that are preferably generated and stored in accordance with the teachings herein. Each data locator code 2 is preferably unique and can serve as an index value, such as for database management.

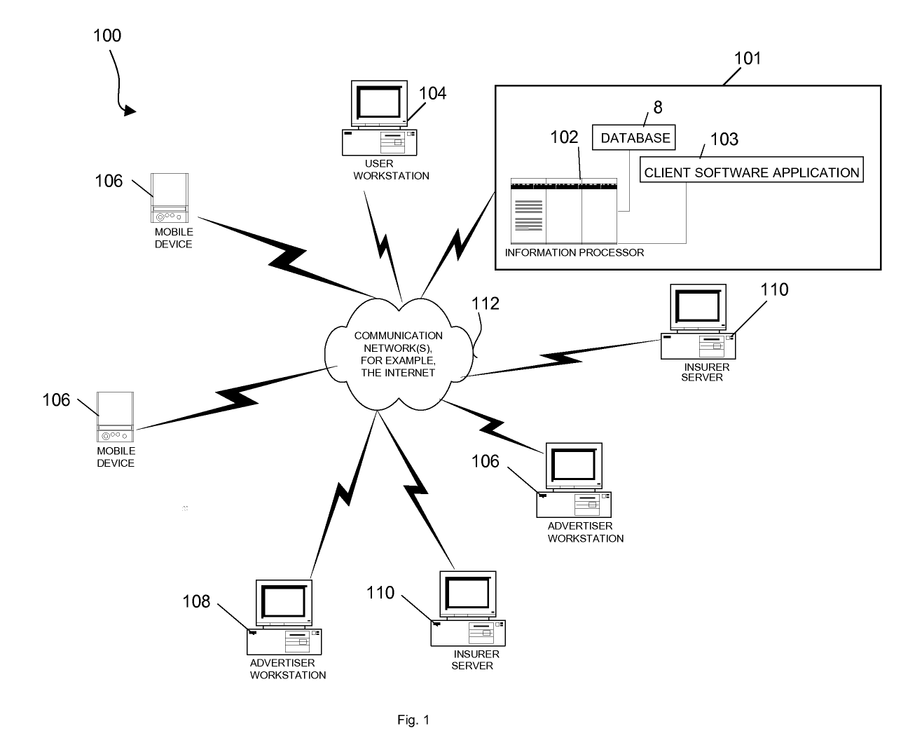

FIG. 1 shows an example hardware arrangement in accordance with an embodiment, referred to generally as system 100. In the embodiment shown in FIG. 1, system 100 comprises at least one information processor or server 102 that is operatively coupled to database 8. Information processor 102 is also configured to distribute and communicate with client software application 103, which provides additional functionality and is described in greater detail below. Together, the processor 102 and the client software application 103 etc., constitute the central server 101. Information processor 102 is configured to access communication network 112, and to communicate with various computing devices, including user workstations 104, mobiles devices 106, advertiser workstations 108 and insurer workstations 110. Information processor 102 may further be configured to operate as a hypertext transport protocol (“HTTP”) internet web server and/or a file transfer protocol (“FTP”) server to send and receive information, and to access and update database 8.

Preferably, information processor 102 and computing devices 104, 106, 108, 110 communicate via the known communications protocol, Transmission Control Protocol/Internet Protocol (“TCP/IP”). In this way, content can be transmitted to and from the devices and commands can be executed to enable the various functionality described herein.

Information processors 102 and computing or interface devices 104, 106, 108 and 110 are, depending on their configurations, any devices that are capable of sending and receiving data across communication network 112, including, for example, mainframe computers, mini computers, personal computers, laptop computers, personal digital assistants (PDA), mobile communication devices such as telephones and internet access devices. In addition, information processor 102 and computing devices 104, 106, 108 and 110 may be equipped with one or more internet web browsers, such as MICROSOFT INTERNET EXPLORER, MOZILLA FIREFOX, SAFARI or the like. Thus and as envisioned herein, information processor 102 and/or computing devices 104, 106, 108 and/or 110 are devices that can communicate over a network and can be operated anywhere, including, for example, from vehicles.

In a preferred embodiment, various kinds input and output devices are utilized in system 100. Although many of the devices interface (e.g., connect) with a computer, it is envisioned herein that many of the devices can operate without any direct connection to a computer. Moreover, various so-called “peripheral” devices may be included in system 100 including, for example, imaging equipment (e.g., cameras), voice recording equipment and global positioning system (“GPS”) technology. Such peripheral devices may also send and receive data to and from information processor 102 and/or computing devices 104, 106, 108 and/or 110.

The nature of the present invention is such that one skilled in the art of writing computer executable code (i.e., software) can implement the described functions using one or more of a combination of popular computer programming languages and development environments including, but not limited to C, C++, Visual Basic, JAVA, PHP, HTML, XML, ACTIVE SERVER PAGES, JAVA server pages, servlets, MICROSOFT.NET, and a plurality of various web site development applications.

For example, data may be configured in a MICROSOFT EXCEL spreadsheet file, as a comma delimited ASCII text file, as a MICROSOFT SQL SERVER compatible table file (e.g., MS-ACCESS table), or the like. In another embodiment, data may be formatted as an image file (e.g., TIFF, JPG, BMP, GIF, or the like). In yet another embodiment, data may be stored in an ADOBE ACROBAT PDF file. Preferably, one or more data formatting and/or normalization routines are provided that manage data received from one or more of a plurality of sources. In another example, data are received that are provided in a particular format (e.g., MICROSOFT EXCEL), and programming routines are executed that convert the data to another format (e.g., ASCII comma-delimited text).

It is contemplated herein that any suitable operating system can be used on information processor 102 and computing devices 104, 106, 108 and/or 110 and, may be, for example, DOS, WINDOWS 3.x, WINDOWS 95, WINDOWS 98, WINDOWS 2000, WINDOWS VISTA, WINDOWS XP, WINDOWS 7, WINDOWS NT, MAC OS, UNIX, LINUX, PALM OS, POCKET PC, BLACKBERRY or any other suitable operating system. Further, the teachings herein support various programming languages and/or software development environment environments, such as JAVA, JAVA Script, Action Script, Swish, or the like. Moreover, a plurality of data file types is envisioned herein. For example, the present invention preferably supports various suitable multi-media types, including but not limited to JPEG, BMP, GIF, TIFF, MPEG, AVI, MP4, SWF, RAW or the like (as known to those skilled in the art).

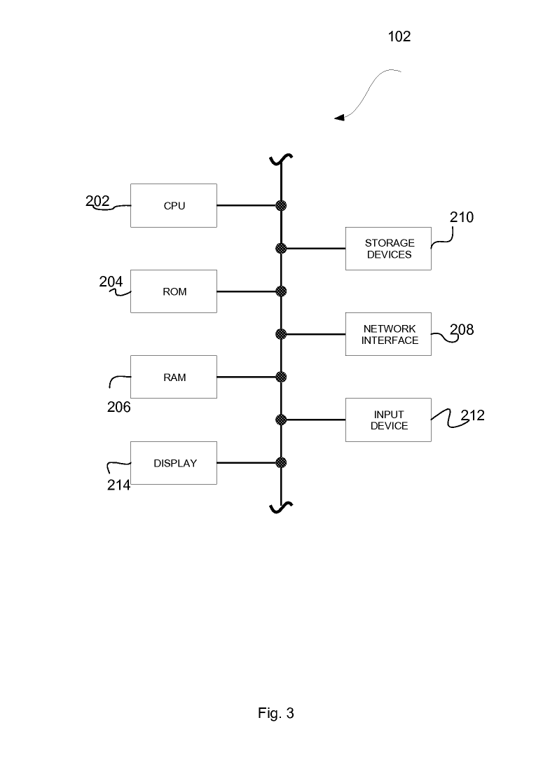

FIG. 3 illustrates the functional elements of an information processor 102 and/or computing devices 104, 106, 108 and/or 110, which typically include one or more central processing units (CPU) 202 used to execute software code and control the operations of the devices, read-only memory (ROM) 204, random access memory (RAM) 206, one or more network interfaces 208 to transmit and receive data to and from other computing devices across the communication network, storage devices 210, such as a hard disk drive, floppy disk drive, tape drive, CD ROM, flash or other electronic memory, or other memory for storing program code, databases, application data and other data, one or more input devices 212 such as a keyboard, mouse, track ball, touch pad, touch screen, microphone, camera or the like, and a display 214.

The various components of information processor 102 and/or computing devices 104, 106, 108 and/or 110 need not be physically contained within the same chassis or even located in a single location. For example, storage location 210 may be located at a site that is remote from the remaining elements of information processor 102, and may even be connected to CPU 202 across communication network 112 via network interface 208. Information processor 102 preferably includes a memory equipped with sufficient storage to provide the necessary databases, forums, and other services, as well as acting as a web server for communicating hypertext markup language (HTML), FLASH, Action Script, Java, Active Server Pages, Active-X control programs to computing devices 104, 106, 108 and/or 110. Information processor 102 is preferably arranged with components, for example, those shown in FIG. 3, that are suitable for the expected operating environment of information processor 102. The CPU(s) 202, network interface(s) 208 and memory and storage devices are selected to ensure that the capacities are arranged to accommodate expected demand.

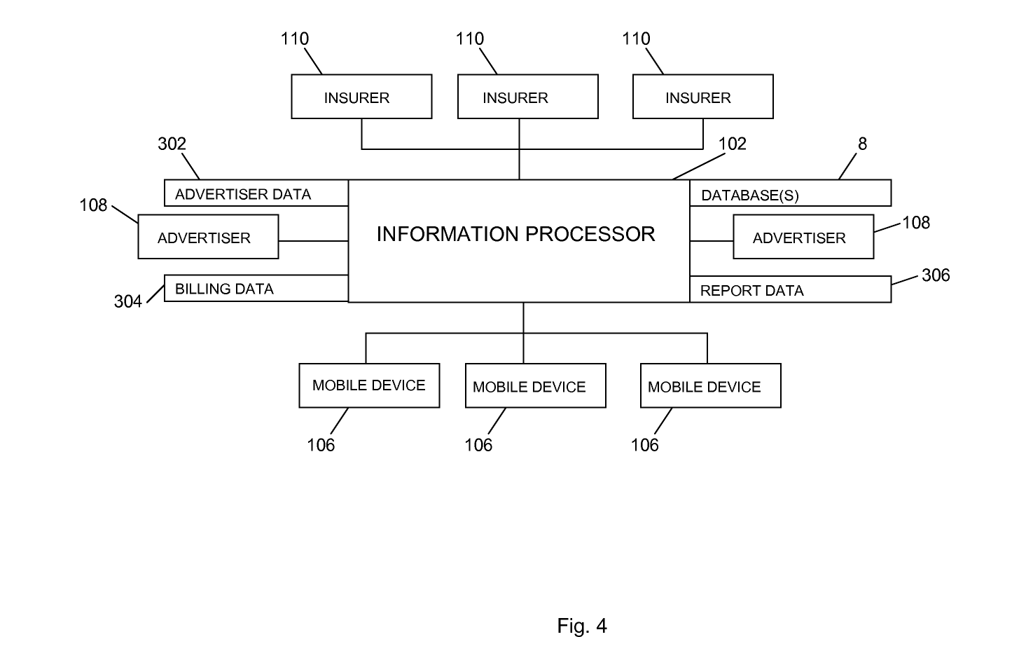

FIG. 4 illustrates a block diagram that represents parties and corresponding computing devices and resources in connection with an embodiment. As shown in FIG. 4, information processor 102 is operatively coupled to mobile device users 106, advertisers 108 and insurers 110. Information processor 102 is also operatively coupled to database 108, as well as to advertiser data 402, billing data 404, and report data 406. As described in greater detail below, information received from advertisers, insurers and users of mobile devices may be used to provide various kinds of information thereto and to generate revenue therefrom.

In a preferred embodiment, client software application 103 is distributed and installed on one or more mobile computing devices 106, such smart phones (e.g., BLACKBERRY, IPHONE, DROID or the like), personal digital assistants, or other mobile devices that can be carried by persons. In an embodiment, a person connects to a web site or other software distribution site, such as provided via information processor 102, and downloads a copy of the client software application 103 to be installed on mobile device 106. In an alternative embodiment, the client software application 103 is installed on a user workstation 104, which may be a desktop computer, notebook computer, netbook computer or other computer.

In an embodiment, after the client software application 103 is downloaded, the user installs the application 103 and a series of steps are executed to obtain various kinds of information. The user is preferably prompted to submit at least some personally identifiable information, which is used by information processor 102 to generate and/or assign a data locator code 2 to the user and/or client software application 103. The data locator code 2 is useful for quickly and anonymously identifying the user, as well as an associated vehicle or several vehicles and provide information relevant thereto.

The data locator code 2 that is to be assigned to client software application 103 may have been previously generated by information processor 102. For example, a user purchases a new automobile insurance policy. Prior to issuing the policy, the insurer 110 contacts information processor 102 and requests a data locator code 2 for the user. If the information processor 102 has already generated a data locator code 2 for the user, then the previously generated data locator code 2 is transmitted to the insurer 119. Alternatively, if the system has not yet generated a data locator code for the user, or if the user has already been assigned a data locator code by the system but not for the particular vehicle that the user is now insuring, then a new unique data locator code 2 is generated and transmitted to the insurance company. Thus, it is possible that a data locator code 2 is generated by information processor 102 for a user without any installation or use of client software application 103. Later, when a user installs the client software application 103, the information processor 102 retrieves the data locator code 2 from database 8 and assigns the data locator code 2 to the client software application 103. Moreover, a plurality of data locator codes 2 may be assigned for a single client software application 103 installation in case, for example, the user drives more than one vehicle.

Alternatively, the data locator code 2 may be generated for the first time during an initial installation of the client software application 103. In that case, the user submits personally identifiable information in the mobile computing device 106 in response to one or more prompts provided by the software 103, and the information is received and used by information processor 102 to generate a new unique data locator code 2. In an embodiment, after a new data locator code 2 is generated during the installation process of client software application 103, information processor 102 polls insurers 110 to locate the respective insurer 110 of the user. The user may identify the insurer 110 in response to one or more prompts, in which case information processor 102 may contact that insurer 110 directly. Once the insurer is located, then additional information may be obtained by information processor 102 and used to configure and/or customize the user's client software application 103. If, during the installation of client software application 103, the user is not insured by any insurer (e.g., the user is not a driver), then information processor 102 may store information about the user for future use.

Preferably, revenue is generated by the client software application 103 that is installed on each user's mobile device 106. In an embodiment, advertising revenue is generated by one or more advertisements that are electronically displayed on the mobile device 106. For example, once a month an advertisement is displayed for an advertiser who contracts with information processor 102. The advertisement may be displayed in various ways, including regardless of whether the user launches the client software application 103 on his/her mobile device 106. Database 8 preferably stores information representing advertisers 108 and/or advertisements that are provided periodically for users. Moreover and in an embodiment, particular advertisements are provided for users in particular contexts. For example, a user is in an accident involving a dented vehicle door, and an advertisement is automatically selected and provided to the user for an auto body repair shop that specializes in vehicle doors. Thus, the teachings herein generate advertisement revenue in various ways and times.

Moreover, each user may be charged a small fee to download and install the client software application 103. The fee may be billed directly from an account, such as an ITUNES account, or a user may submit credit card or other payment information to download and install the software 103.

In addition to generating revenue from users (e.g., drivers), the teachings herein provide for generating revenue from insurers 110. For example, insurance companies 110 may be charged a small fee for each data locator code 2 generated for the insurer's respective customers. Moreover, and as described in greater detail below, information processor 102 may provide a gateway for insurers 110 to receive information about insured customers, such as immediately after an accident occurs or after some other event that requires the insurer 110 to be notified. The teachings herein enable users, e.g., via mobile computing devices 106, to substantially automatically contact information processor 102, and information processor 102 automatically contacts insurance companies 110 on behalf of the users. Information that is obtained by information processor 102 is valuable for insurers 110, and insurers 110 may request that information processor 102 provide data in reports that are particularly formatted for the insurers. In this way, information processor 102 provides a service to insurers 110 by streamlining production of data and information in custom tailored ways. Insurers 110 are desirous of receiving data according to pre-formatted definitions for cost and timesaving purposes. Also, receiving live information about accidents, including possibly on scene photos is highly valuable to insurance companies, for which they would readily pay appropriate fees.

In another embodiment, each user's insurer 110 is charged a small fee each time one of the insurer's 110 customers downloads and/or installs client software application 110. In this way, customers are not directly charged for use of teachings herein, and insurance companies 110 that receive benefit from the teachings herein are charged.

In an embodiment, each person's data locator code 2 is printed on an insurance card that may be printed by a respective insurance company 110 and provided to the person. The insurance card that includes the data locator code 2 is kept with the vehicle that the person drives. This provides easy access to data locator codes 2, as people can simply refer to their insurance cards in the event they forget their data locator codes 2. In an embodiment, the data locator code 2 may also be embedded in a bar code that is printed on the insurance card. Furthermore and in an embodiment, a plurality of data locator codes 2 may be printed on a single insurance card. Each of the data locator codes may represent, for example, the vehicle and a respective authorized driver of the vehicle. For example, a plurality of data locator codes 2 are printed for drivers who are the husband, wife, son and daughter of a family.

As noted above, client software application 103 is preferably installed on a computing device 104/106, and the software is configured with one or more data locator codes 2 representing the user and the vehicle(s) operated by the user. In an embodiment, the client software application 103 includes functionality for controlling the respective device on which it is installed. For example, many mobile devices 106, such as smartphones, include cameras that record still images and/or video. The client software application provided in accordance with an embodiment may interface with the mobile device, thereby enabling a user to take pictures and/or video of an accident scene and establish a record of the scene. This provides a record of evidence of particular damage, including to assess fault and degree of harm, and is captured at the scene using the client software application 103. In an embodiment, the evidence is be transmitted substantially automatically to information processor 102 via the mobile device 106.

Moreover, it is possible that a party to an accident does not have a data locator code 2 assigned. In this case, a user may be instructed by the client software application 103 to take pictures of, for example, a vehicle identification number (“VIN”), an insurance card, license plate, or other identifying sources of information of one or more parties to an accident or other event. It is recognized by the inventor that privacy concerns may exist by enabling a user who is in, for example, a motor vehicle accident, to capture sensitive or private information of another party on his/her mobile device 106. Accordingly and in an embodiment, the client software application 103 causes the mobile device 106 (or other device on which the software is installed) to transmit images and other content regarding an accident and that may include sensitive or private information to the information processor 102, and then to delete the images or content automatically from the mobile device 106. In this way, no sensitive and/or private information is stored on a user's mobile or other device. The client software application 103 assures that personally identifiable information and private/sensitive information is not saved.

In addition to capturing images, the client software application 103 may further interface with a global positioning system (“GPS”) provided with a mobile or other device 106. By utilizing GPS technology, location information can be quickly and automatically determined and transmitted to information processor 102. This may be useful for providing an evidentiary record, as well as for dispatching emergency medical care and law enforcement quickly and accurately to the scene of an accident, if needed.

Further, the client software application 103 may be configured to cause one or more HTTP requests to one or more servers to gather information. For example, an HTTP request may be transmitted for current weather conditions, traffic conditions, and other information associated with a particular scene of an accident or other event. By utilizing HTTP, a variety of information associated with a particular event (e.g., an accident) may be quickly and automatically retrieved and transmitted to information processor 102.

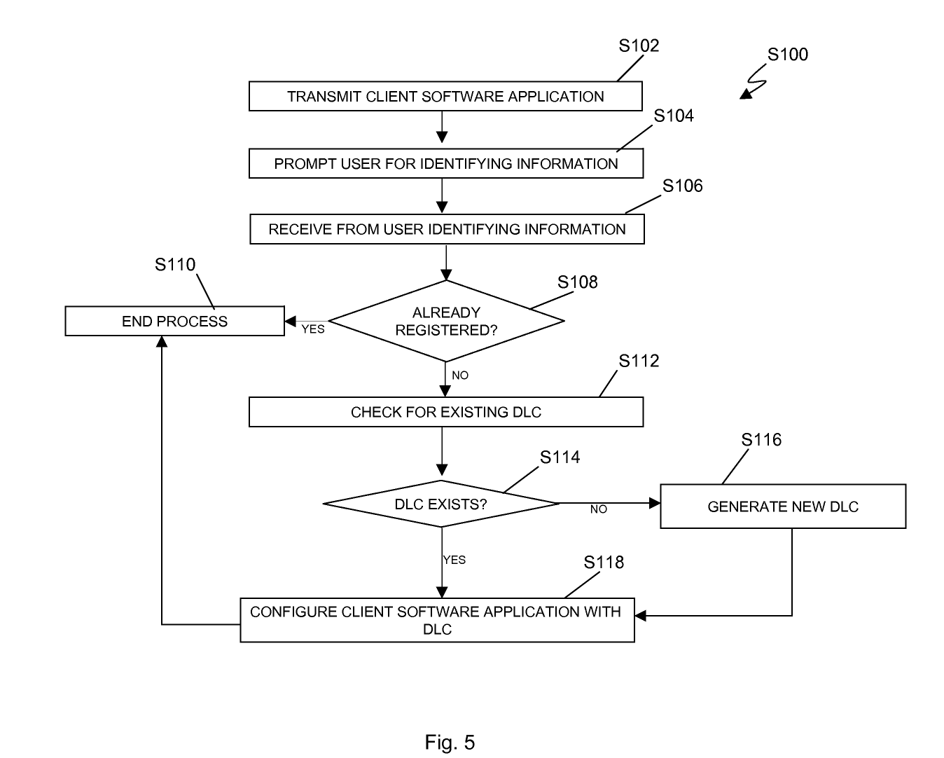

Referring to the drawings, FIG. 5 is a flow chart illustrating example steps S100 associated with installing client software application 103 on a user's mobile computing device 106. In step S102, information processor 102 transmits client software application 103 to a user's mobile computing device 106. During the installation process, the user is prompted to submit identifying information, such as the user's name, date of birth, social security number, or other personally identifiable information (step S104). The user submits the information in the mobile device 106 and the personally identifying information is received from the user computing device 106 (step S106). Thereafter, a determination is made at step S108 whether the software application that is being installed has already been registered with information processor 102. If so, then the process branches to step S110, and ends. Alternatively, if the software has not been registered with information processor 102, then information processor 102 checks to see if an existing data locator code 2 has already been assigned for this particular user (step S112). Thereafter, a determination is made at step S114 whether the data locator code 2 exists for this user. If not, then information processor 102 generates a new data locator code 2 (step S116). Thereafter, the process continues to step S118, and the client software application 103 is configured with the data locator code 2. If, alternatively, at step S114 the information processor 102 determines that a data locator code 2 exists already for this user, then the process branches to step S118 and the client software application 103 is configured with the respective data locator code 2. Thereafter, the process ends at step S110. In one embodiment, the user may opt to provide only minimal personal information, and indicate that a more complete data record is available at a particular insurance company. Thereby, central server 102 may call on insurance companies to supply information to the mobile devices involved in or reporting an accident.

Other features may be utilized or otherwise provided that are utilized by the client software application 103 and the teachings herein. For example, a voice message capsule may be recorded and/or transmitted by a user to information processor 102 that describes the scene of an accident or provides evidence of the scene. Moreover, a date/time stamp may be automatically provided to information processor 102 by the client software application 103. Moreover, device information (e.g., a media access control (“MAC”) address) may be obtained by client software application 103 and transmitted to information processor 102. These data provide additional evidence.

As will be appreciated by one of ordinary skill in the art, the teachings herein protect against various misrepresentations, as memories of an event fade or otherwise change. One or more features provided by the teachings herein are useful to establish an accurate and timely record of events and conditions that, for example, prevent one or more parties from fabricating or otherwise misidentifying facts and conditions that occurred as of the time of an event. For example, a user of a mobile device 106 configured with the client software application 103 sends still images and video at the scene of a motor vehicle accident to the information processor 102. The images portray a quiet road, and just the user and the other driver (with no other people to the accident being present). Once the information is received by the information processor 102 and the information processed in accordance with the teachings herein, the parties quickly depart the scene. In the future, each party is precluded from alleging that other witnesses were on the scene, including from fabricating evidence of fault and/or injury. Thus, a factual record is preferably generated in accordance with the teachings herein, and parties are unable to change facts (intentionally or otherwise) in the future. In addition to preventing parties from misrepresenting at some future time facts that occurred during an accident, the teachings herein are also useful for reducing the likelihood of a party alleging new injury. Thus, the teachings herein reduce a likelihood of outright fraudulent assertions of new injury being upheld.

A benefit of the present invention is that parties can quickly and efficiently resolve matters in a fender bender. It is recognized by the inventor that many motor vehicle accidents occur in which no personal medical injury occurs and no medical attention is required. The teachings herein are well-suited for such accidents, as users can exchange their respective data locator codes 2, transmit images and other content of the scene to information processor 102, wait for confirmation from information processor 102 that information has been received and/or processed, and the users can be on their way.

In some cases, only one user may be registered with information processor 102, and the registered user may transmit the other party's VIN, license plate or other information to information processor 102. Upon receipt of this information, information processor 102 may poll one or more insurance companies 110 to locate the other party's respective insurer 102. When a match is found, the parties may proceed with the one registered user's configured computing device 106 for transmitting information to information processor 102 for processing, substantially as described herein.

In the event that only one party to an accident is registered and the information processor 102 is able to locate the other party's insurer 110, information processor 102 may automatically register the other party and generate and assign a new data locator code 2 therefor. The new data locator code 2 may be transmitted to the respective insurer 110 of the other party, and the other party may be prompted, such as via e-mail, to download and install client software application 103 on the other party's mobile device 103. This enables a seamless proliferation of data locator codes 2 and client software application 103.

In other cases, of course, motor vehicle accidents are more serious and personal injury occurs that requires medical care. In that case, users of a mobile or other computing device 110 configured with the client software application 103 select one or more options to request immediate care, such as ambulance and/or police dispatch. If the user is able to respond further, then the user may submit additional accident information, which may be used to dispatch authorities and for processing the accident by information processor 102. Alternatively, if the user is unable to respond, then care may be automatically dispatched, for example, using GPS or other technology. In an embodiment, a user may request towing vehicles, which the central processor can quickly locate and dispatch. In another embodiment, the client software may be responsive to an icon initiated step to automatically dial relative(s) or friend(s) of the user and provide them with directions to the accident site.

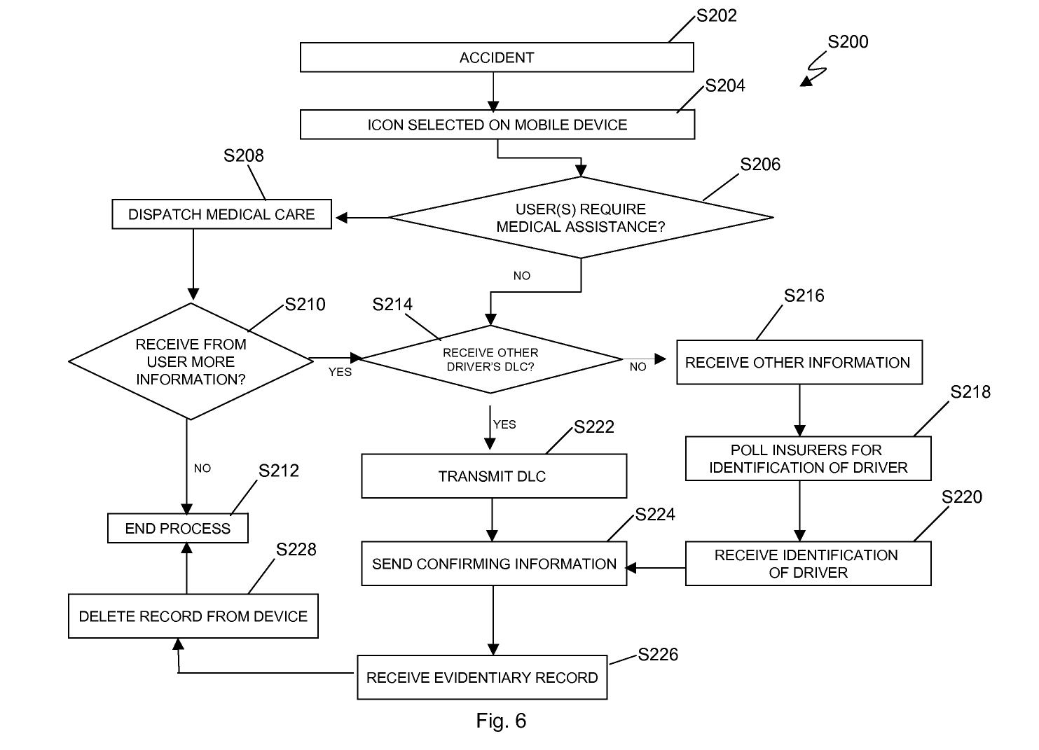

FIG. 6 is another flowchart illustrating steps S200 associated with an example embodiment. The flowchart illustrated in FIG. 6 includes steps that are provided in accordance with an example embodiment after a motor vehicle accident takes place (step S202). Thereafter, a user having the client software application 103 installed and properly configured on his mobile device 106 selects an icon to launch client software application 103 (step S204).

Continuing with the example flowchart shown in FIG. 6, it is recognized by the inventor that some motor vehicle accidents may take place in which there is personal injury, potentially serious, that requires immediate medical attention. In a preferred embodiment, prior to a user identifying information, such as for a fender bender type accident, an initial prompt is provided by client software application 103 that enables a user to easily and quickly request medical help. For example, after the client software application 103 is launched, two relatively large icons appear: one for requesting immediate medical care and one for all other options. In case the user selects the option for immediate medical care, then the user may provide information such as where the user is located, the type of injury, or the like. Alternatively, the user may be prompted to select an icon that automatically telephones emergency dispatch. Alternatively, if the user is unable to respond beyond pressing the first icon to request immediate medical care, the client software application 103 may invoke GPS or other location technology to identify the physical location of the user, and to dispatch care.

In case the user selects an option that immediate medical assistance is required, the process branches to step S208 and medical care is dispatched. Thereafter, the process branches to step S210 and a determination is made whether more information can be received from the user. If not, then the care is dispatched and the process ends at step S212. Alternatively, if the determination at step S210 is that additional information can be received from the user, then the process branches to step S214 and the user is prompted to enter the other party's (e.g., driver's) data locator code 2. If a determination in step S214 is that the other driver's data locator code 2 cannot be provided, then the process branches to step S216 and other information is received from the user.

For example, and as described above, the user may transmit to information processor 102 data representing the other driver's VIN, license plate, insurance card, driver name or social security number, or any other information that may assist information processor 102 from locating insurance information for the other driver. For example, an image may be taken by the mobile device 106 via client software application 103 of the vehicle information number. Alternatively, an image may be taken of the other driver's insurance card, which is transmitted to information processor 102. As noted above and in a preferred embodiment, client software application 103 causes any images that are taken via client software application 103 to be automatically deleted after such images are transmitted and received by information processor 102. In this way, private or other sensitive data are not stored on a user's mobile device 106, which increases a likelihood that parties will be comfortable using technology substantially as described herein.

Continuing with reference to FIG. 6, after information is received in step S216, the process continues to step S218, and information processor 102 polls insurers 110 for an identification of the driver and/or the driver's insurance policy. For example, information processor 102 sends out a request to insurers 110 with some identifying information regarding the other driver, such as the other driver's license plate or VIN, and a respective insurer 110 replies back with the relevant information (see for example, FIG. 4). Thereafter, the identification of the other driver is received (step S220). The process continues to step S224 and information processor 102 transmits some confirming information to client software application 103 that is usable by the user to identify the other driver. This enables the user to confirm that the other driver has been properly identified by information processor 102 and that proper insurance information has been obtained.

For example, and as described above, a plurality of drivers may be authorized to drive the other driver's automobile, such as the other driver's wife, daughter and son. After information processor 102 receives that information from the respective insurer 110, information processor 102 transmits to client software application 103 the first names of the authorized drivers and brief descriptions, such as their ages. The user, thereafter, can verify to information processor 102 the identity or other information of the other driver, to enable final processing of the accident. If, in the determination at step S214 that the other driver has a data locator code 2, then the user transmits that data locator 2 to information processor 102 (step S222). Thereafter, the process continues to step S224 and the confirming information is transmitted from information processor 102 for the user to confirm the identity of the other driver.

Continuing with reference to FIG. 6, after confirming information has been received by the user in step S222, an evidentiary record is established, for example, via voice memoranda, images or video that are taken by the user's mobile device 106. The evidentiary record may include, for example, statements from the drivers that no physical injury occurred that would have required medical attention. Other data may include images of witnesses, weather and/or road conditions. Other data may include date and time stamps, as well as information received from web servers regarding traffic conditions, and/or vehicle information provided by one or more motor vehicle departments. Thus, any information that may be electronically prepared and transmitted to information processor 102, including via mobile device 106 or any web server, may be included in the evidentiary record provided in accordance with the teachings herein. As noted above, establishing a record in this way reduces or otherwise precludes a likelihood of future fraudulent or inaccurate allegations in connection with potential injury or other harm. Thereafter, after the evidentiary record is received by information processor 102 at step S226, the evidentiary record, including images and other data, are deleted from the user's mobile device 106 (step S228). The process ends at step S212. When the process ends, the two drivers, provided their automobiles are in a drivable condition, depart the scene. The teachings herein obviate the need for law enforcement to spend time and resources assessing a scene where such law enforcement is not needed.

An example describing various features of the teachings herein is now provided in connection with a minor motor vehicle accident.

Two vehicles collide at a stop sign. Prior to the accident, the driver of one vehicle had not noticed that the other vehicle was stopped at the stop sign, and turned sharply to avoid the stopped vehicle. The vehicle that was previously stopped at the stop sign was struck lightly in the right rear corner, causing some minor damage to the bumper, taillights and fender.

Continuing with this example, both drivers get out of their vehicles and immediately determine there was no medical injury. One driver had previously installed on his BLACKBERRY telephone the client software application 103, and the driver selected the appropriate icon to launch the client software application. Using the client software application 103, the driver responds to prompts that there is not medical injury, and that there is relatively minor damaged caused to one of the vehicles. The other driver does not have the client software application 103 installed on a device, but does have an insurance card with his data locator code 2 imprinted thereon. The driver operating the client software application 103 enters the other driver's data locator code 2 into client software application 103, which is transmitted to information processor 102. The client software application 103 prompts the user to enter additional information describing the accident, including via text and voice, and then to aim his BLACKBERRY camera lens at the vehicle to photograph the damage to the vehicle.

Continuing with this example, while the driver who is registered user is in the process of providing accident-related information to the client software application 103, information processor 102 references the other driver's data locator code 2 and contacts the other driver's insurer and notifies the insurer that the accident has taken place. After the registered user completes entering information regarding the accident, the client software application 103 uploads the information to information processor 102, and then deletes the information from the user's mobile device 106. Thereafter, information processor 102 compiles the information, and generates one or more reports for the insurers of the drivers, and sends a confirmation to the registered user's mobile device 106 that the information has been received and processed, and the parties can depart the scene. Since both vehicles can be safely driven, no medical injury occurred and the drivers are in agreement, there is no need for police or medical response personnel to be dispatched. The entire accident takes minutes to process before the parties depart.

Thus, in accordance with the preferred embodiments, a data locator code 2 is provided that is formatted to represent at least a driver and a motor vehicle, such as an automobile or motorcycle. The code is generated and established by information processor 102, and used as an index for one or more insurance companies 110, database(s) 8 and client software application 103. After an accident occurs, particularly a relatively minor fender bender type accident, information is automatically generated and provided for insurers 110 as a function of data and communication connections to information processor 102 (FIG. 4). In an embodiment, after an accident occurs and data retrieved from client software application 103, custom-tailored and properly formatted reports may be generated by information processor 102 and provided for insurers 110 for a fee. Moreover, advertisement revenue may be generated by providing advertisements on client software application 103 periodically or otherwise in a particular context following, for example, an accident.

Among other benefits provided in accordance with the teachings herein, overall costs associated with fender bender collisions are substantially reduced, particularly by saving law enforcement and emergency care resources from being unnecessarily expended. Further, the teachings herein provide a systemized and universal application of a data locator code 2 that is relatively easy to memorize and can be used as a primary index to retrieve substantial amounts of related data. In one embodiment, the use of the teachings herein may inspire legislatures to enact laws that substantiate and require the use of client software application 103, and the corresponding evidentiary records that are provided thereby. For example, rules of evidence may be provided for admission of such images and voice records that are received by information processor 102 into court.

Moreover, the use of client software application 103 assures that no private or otherwise sensitive and confidential information that relates to an individual or party is stored on a mobile device 106, thereby increasing a level of trust and confidence of the public at large in connection with the present application.

In addition to costs that are reduced as a function of reducing the need for resources, the entire process is fast, and parties to an accident using the teachings herein are able to depart the scene in substantially less time than would otherwise be required in the prior art. In literally just a matter of minutes, an accident may take place, the drivers meet and determine that they require no medical care and that the damage to their vehicles is relatively minor. One or more of the parties may transmit to information processor 102 one or more data locator codes 2 and receive confirmation back from information processor 102 that the respective insurance companies have been contacted and that the parties and vehicles have been positively identified. Thereafter, the parties can depart the scene and be on their way. Thus, what could normally take hours to complete can now be provided in a matter of minutes in accordance with the teachings herein.

Further, an evidentiary record is preferably established, for example, by pictures and/or video, and/or voice memoranda and that are transmitted to information processor 102. By providing an evidentiary record, witnesses can be confirmed as either being present or not being present at the scene, various conditions can be confirmed, such as weather, traffic, road and/or vehicle conditions, thereby reducing a likelihood of fraud or other deception.

Other benefits provided in accordance with the teachings herein include identifying a person while maintaining a degree of anonymity. For example, the confirming identifying information received from information processor 102 upon transmission of a particular party's data locator code 2 may include simply a description of the person without any indication of the person's name, social security number, date of birth or other personally identifiable information.

Alternatively, the information processor 102 may transmit confirming information that includes the make, model and color of the vehicle involved in the accident. Further, the teachings herein provide a newly forged relationship with insurance companies and providers, which may further reduce costs and provide additional benefits therefor. For example, insurance companies that would otherwise have to compile data from disparate sources can now obtain data from a single source (e.g., information processor 102) and can further receive information in predefined and preferred formats, thereby reducing a need for personnel or processes to format data received from disparate sources in preferred ways.

Therefore, the teachings herein provide a fraud deterrent and keeps parties from alleging inaccurate facts, such as witnesses being present on the scene who were not there or alleging damage, injury or the like. By establishing an evidentiary record immediately on the scene and essentially in real time, the teachings herein preclude any addition of new and inaccurate facts to any case.

Although the present invention has been described in relation to particular embodiments thereof, many other variations and modifications and other uses will become apparent to those skilled in the art. Although many of the examples and features described herein relate to motor vehicles, the invention is not so limited. The teachings herein may be applicable for various other forms of insurance, including health, life and property insurance. It is preferred, therefore, that the present invention be limited not by the specific disclosure herein.

What is claimed is:

1. A vehicle accident recording system, comprising:
at least one central server programmed with server software and communicatively coupled with a database containing at least one thousand pre-registered users;
a plurality of palm-sized client mobile devices, each programmed with client software which enables it to execute a step by step protocol for gathering and registering with the central server information about accident scenes; and
at least one insurance carrier server configured to be called upon by the central server and to communicate with the central server about identification information of vehicles and/or individuals involved in vehicle accidents, wherein
said client software is configured to provide a user with a menu of steps to follow at the scene of a vehicle accident which include at least identifying the location of the accident scene and gathering identification information about a user's vehicle in the accident, the user, and vehicle and/or driver information of at least one other vehicle involved in a given accident.

2. The system of claim 1, wherein said protocol step of gathering information about the other vehicle and/or driver comprises inputting into the client mobile device at least one of a data locator code associated with at least one of said other vehicle and other driver; a vehicle VIN number, a vehicle license plate number and a vehicle insurance policy number.

3. The system of claim 2, wherein said service software vehicle and/or driver identification protocol comprises automatically communicating to the at least one insurance carrier server information received from the client mobile device and obtaining therefrom more detailed information concerning the vehicle and/or driver involved at a given accident and communicating said information to the client mobile device for on-site verification by the user.

4. The system of claim 3, wherein the personal information about the vehicle and the driver is configured to be flashed onto the client mobile device for a limited period of time, solely for on-site verification of the data by the user.

5. The system of claim 2, wherein the data locator code is configured to have eight or less characters which are capable of uniquely identifying a vehicle or a driver authorized to drive the vehicle, or both a vehicle and a driver.

6. An accident reporting system, comprising:
at least one processor operatively coupled to processor readable media;
at least one communication device operatively coupled to the at least one processor for communicating over a network;
at least one database stored on the processor readable media, the at least one database storing:
a plurality of electronic data locator codes that respectively represent a plurality of parties and one or more vehicles that the parties are respectively authorized to drive;
electronic advertisements associated with a plurality of advertisers;
electronic insurer information representing a plurality of insurers,
wherein at least one of the plurality of insurers insures at least one of the plurality of parties;
wherein the processor readable media stores instructions for causing the at least one processor to:
receive, from a computing device and via the at least one communication device, an electronic notification of an accident event involving two parties, wherein the electronic notification includes a first of the electronic data locator codes associated with a first party involved in the accident event;
transmit to the computing device a prompt for information representing the accident event;
receive, from the computing device and in response to the prompt, a second of the data locator codes associated with a second party involved in the accident event; and
transmit, via the communication device, information representing the accident event to at least one computing device associated with at least one of the insurers that insures the first party and the second party.

7. The system of claim 6, wherein the electronic notification is received from a client software application provided by the at least one processor.

8. The system of claim 7, wherein the client software application is installed on the computing device.

9. The system of claim 6, wherein the instructions further cause the at least one processor to:
transmit to the computing device a prompt for at least one image of the accident event; and receive, in response to the prompt, the at least one image.

10. The system of claim 9, wherein the electronic notification is received from a client software application installed on the computing device and, further wherein the client software application programs and configures the computing device to delete the at least one image from the computing device, after a brief period of no longer than several minutes.

11. The system of claim 6, wherein the instructions further cause the at least one processor to generate the plurality of data locator codes stored in the database.

12. The system of claim 6, wherein the instructions further cause the at least one processor to transmit to at least one of the insurers at least one of the data locator codes.

13. The system of claim 6, wherein the instructions further cause the at least one processor to:
receive, via the at least one communication device and from the at least one computing device associated with the at least one of the insurers, a request a report of the accident event;
generate the report of the accident event; and
transmit, via the at least one communication device and to the at least one computing device associated with the at least one of the insurers, the report.

14. The system of claim 6, wherein the instructions further cause the at least one processor to transmit, via the at least one communication device, at least one of the electronic advertisements to the computing device.

15. A vehicle accident reporting system, comprising:
at least one processor operatively coupled to processor readable media;
at least one communication device operatively coupled to the at least one processor for communicating over a network;
at least one database stored on the processor readable media, the at least one database storing:
a plurality of electronic data locator codes that respectively represent a plurality of parties and one or more vehicles that the parties are respectively authorized to drive;
electronic insurer information representing a plurality of insurers, wherein at least one of the plurality of insurers insures at least one of the plurality of parties;
wherein the processor readable media stores instructions for causing the at least one processor to:
receive, from a computing device and via the at least one communication device, an electronic notification of an accident event involving two parties, wherein the electronic notification includes a first of the electronic data locator codes associated with a first party involved in the accident event;
transmit to the computing device a prompt for information representing the accident event;
receive, from the computing device and in response to the prompt, information associated with a second party involved in the accident event;
transmit, via the communication device, the information associated with the second party to at least one of the insurers; and
receive, via the communication device and from at least one of the insurers, information associated with insurance for the second party.

16. A method, the method comprising:
providing at least one processor operatively coupled to processor readable media and that is operatively coupled to at least one communication device operatively for communicating over a network;
storing, on the processor readable media, at least one database that includes:
a plurality of electronic data locator codes that respectively represent a plurality of parties and one or more vehicles that the parties are respectively authorized to drive;
electronic advertisements associated with a plurality of advertisers;
electronic insurer information representing a plurality of insurers, wherein at least one of the plurality of insurers insures at least one of the plurality of parties;
receiving, from a computing device and via the at least one communication device, an electronic notification of an accident event involving two parties, wherein the electronic notification includes a first of the electronic data locator codes associated with a first party involved in the accident event;
transmitting, via the at least one communication device and to the computing device, a prompt for information representing the accident event;
receiving, via the at least one communication device from the computing device and in response to the prompt, a second of the data locator codes associated with a second party involved in the accident event; and
transmitting, via the communication device, information representing the accident event to at least one computing device associated with at least one of the insurers that insures the first party and the second party.

17. The method of claim 16, wherein the electronic notification is received from a client software application provided by the at least one processor.

18. The method of claim 16, further comprising:
transmitting, via the at least one communication device to the computing device, a prompt for at least one image of the accident event; and
receiving, in response to the prompt and via the at least one communication device, the at least one image.

19. The method of claim 18, wherein the electronic notification is transmitted from a client software application installed on the computing device and, further wherein the client software application programs and configures the computing device to delete the at least one image from the computing device.

20. The method of claim 16, further comprising generating, by the at least one processor, the plurality of data locator codes that are stored in the database.

21. The method of claim 16, further comprising:
receiving, via the at least one communication device and from the at least one computing device associated with the at least one of the insurers, a request a report of the accident event;
generating, by the at least one processor, the report of the accident event; and
transmitting, via the at least one communication device to the at least one computing device associated with the at least one of the insurers, the report.

22. The method of claim 16, further comprising transmitting, via the at least one communication device, electronic advertisements to the computing device.
